(19) United States
(12) Patent Application Publication
(10) Pub. No.: US 2015/0103423 A1
(43) Pub. Date: Apr. 16, 2015

(54) DRIVE DEVICE AND IMAGING APPARATUS

(71) Applicant: SONY CORPORATION, TOKYO (JP)

(72) Inventor: Tetsu TANAKA, Kanagawa (JP)

(21) Appl. No.: 14/492,680

(22) Filed: Sep. 22, 2014

(30) Foreign Application Priority Data
Oct. 15, 2013 (JP) 2013-214725

(51) Int. Cl. G02B 7/04; F16H 21/40

(52) U.S. Cl. CPC G02B 7/04; F16H 21/40
USPC 359/824; 74/89

(57) ABSTRACT

There is provided a drive device including a movable body, and a fixing member that supports, with a drive shaft driven by a piezoelectric element expanded and contracted in response to an applied voltage and a sub shaft provided in parallel with the drive shaft, the movable body connected with the drive shaft movably in an axial direction. The movable body includes a rotation regulating member that supports the sub shaft and regulates rotation of the movable body with the drive shaft as a rotation center, and an impact dispersing part that disperses an impact on the piezoelectric element when inclined to the drive shaft.

### CROSS REFERENCE TO RELATED APPLICATIONS

This application claims the benefit of Japanese Priority Patent Application JP 2013-214725 filed Oct. 15, 2013, the entire contents of which are incorporated herein by reference.

### BACKGROUND

The present disclosure relates to a drive device that moves a movable body and an imaging apparatus.

In recent years, a digital camera has a photographing function of not only still images but also moving images, and not only still image quality but also a photographing performance of the moving images is becoming important. On the other hand, a demand for miniaturization of a camera is also increasing, and there is a need for a small-sized actuator that is capable of highly accurate positioning and is driven quietly. In such a situation, as a drive device that moves a movable body, a piezoelectric actuator which is the drive device using a piezoelectric element has been proposed.

As the movable body to be moved by the piezoelectric actuator, for instance, there are a lens (lens group), an imaging unit and the like. By the piezoelectric actuator, the lens is moved in a direction orthogonal to an optical axis in shake correction, or is moved in an optical axis direction in focusing. Also, the imaging unit is moved in the direction orthogonal to the optical axis in shake correction by the piezoelectric actuator.

In such a manner, by using the piezoelectric actuator as the drive device that moves the movable body, a high-speed operation due to a responsiveness that the piezoelectric actuator has, improvement of accuracy at a stop position of the movable body, retention of the movable body when a current is not supplied and the like can be achieved with a simple mechanism.

In the meantime, the piezoelectric element of the piezoelectric actuator is constructed by laminating a plurality of cells formed of ceramic. Therefore, cracks are generated on a boundary surface of cells and the piezoelectric element is easily damaged by an impact generated by the fall of a device provided with the piezoelectric actuator or the like. When the piezoelectric element is damaged, the piezoelectric actuator is not appropriately operated, and reliability of an operation of the movable body is lowered.

Accordingly, for instance, in the drive device in JP2012-29495A, at least two or more drive shafts and guide shafts are provided, and two or more movable bodies that are guided by the shafts and moved respectively are gently connected with each other with predetermined connection force. Specifically, between the movable bodies, a connection member that connects the movable bodies with each other while allowing an inclination generated between the movable bodies within a predetermined angle range is interposed. Thus, an impact from the movable bodies by the fall or the like to the piezoelectric actuator is received by the guide shaft and burdens on the drive shaft are dispersed. Also, even when the drive shaft and the guide shaft become non-parallel, thrust from the drive shaft is transmitted to the movable body supported on a guide shaft side while the operation of the movable body is not obstructed.

### SUMMARY

However, the drive device described in JP2012-29495A is increased in size since a structure is complicated. Also, since the connection member is interposed between the drive device and the movable body to which the thrust is transmitted, highly accurate control and smooth operations are obstructed.

Accordingly, the present disclosure proposes new and improved drive device and imaging apparatus that are small-sized and capable of preventing damages to a piezoelectric actuator when an impact is generated.

According to an embodiment of the present disclosure, there is provided a drive device including a movable body, and a fixing member that supports, with a drive shaft driven by a piezoelectric element expanded and contracted in response to an applied voltage and a sub shaft provided in parallel with the drive shaft, the movable body connected with the drive shaft movably in an axial direction. The movable body includes a rotation regulating member that supports the sub shaft and regulates rotation of the movable body with the drive shaft as a rotation center, and an impact dispersing part that disperses an impact on the piezoelectric element when inclined to the drive shaft.

According to another embodiment of the present disclosure, there is provided an imaging apparatus including an imaging unit, a lens part composed of one or more lenses that transmit light incident on the imaging unit, and a plurality of drive devices that are provided in the imaging unit and the lens respectively and move the imaging unit and the lens in a predetermined direction respectively. At least one of the drive devices includes a movable body composed of the imaging unit or the lens to be moved by the drive device, and a holding part that holds the imaging unit or the lens, and a fixing member that supports, with a drive shaft driven by a piezoelectric element expanded and contracted in response to an applied voltage and a sub shaft provided in parallel with the drive shaft, the movable body connected with the drive shaft movably in an axial direction. The movable body includes a rotation regulating member that supports the sub shaft and regulates rotation of the movable body with the drive shaft as a rotation center, and an impact dispersing part that disperses an impact on the piezoelectric element when inclined to the drive shaft.

According to the present disclosure, when an impact is applied to an apparatus provided with the drive device, the movable body of the drive device is shifted and inclined to the drive shaft and the sub shaft. At this time, by suppressing transmission of the impact generated by the inclination of the movable body to the piezoelectric element with an impact dispersing part, the damage to the piezoelectric element is prevented. Also, the drive device is provided with a rotation regulating member that regulates rotation of the movable body with the drive shaft as a rotation center, so as to act on the sub shaft together with the impact dispersing part. In this way, by utilizing the sub shaft and providing a function of dispersing an impact to the piezoelectric element and a function of regulating the rotation of the movable body together, a configuration of the drive device is simplified and the drive device is miniaturized.

As described above, the present disclosure makes the miniaturization of the drive device possible, and prevents damage to the piezoelectric actuator when an impact is generated. Note that, the above-described effects are not necessarily definite, and together with the above-described effects, or instead of the above-described effects, one of effects indicated in this specification or other effects that can be recognized from this specification may be demonstrated.

### BRIEF DESCRIPTION OF THE DRAWINGS

FIG. 1 is a perspective view illustrating an appearance of a digital still camera that has a drive device according to an embodiment of the present disclosure;

FIG. 2 is a perspective view illustrating a configuration of the drive device according to the embodiment;

FIG. 3 is a plan view of the drive device according to the embodiment;

FIG. 4 is a planar sectional view of the drive device according to the embodiment;

FIG. 5 is a front view of the drive device according to the embodiment;

FIG. 6 is a sectional view on an A-A cutting line in FIG. 3, and illustrates a state without an inclination of a lens frame; and

FIG. 7 is a sectional view on the A-A cutting line in FIG. 3, and illustrates a state that the lens frame is inclined.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Descriptions will be given in the following order.
1. Configuration of drive device
   1.1. Application example of drive device
   1.2. Configuration
2. Action of drive device
   2.1. Movement of lens frame by piezoelectric actuator
   2.2 Impact dispersing function by lens hole
   2.3. Rotation regulating function by projection parts
3. Summary

<1. Configuration of Drive Device>

[1.1. Application Example of Drive Device]

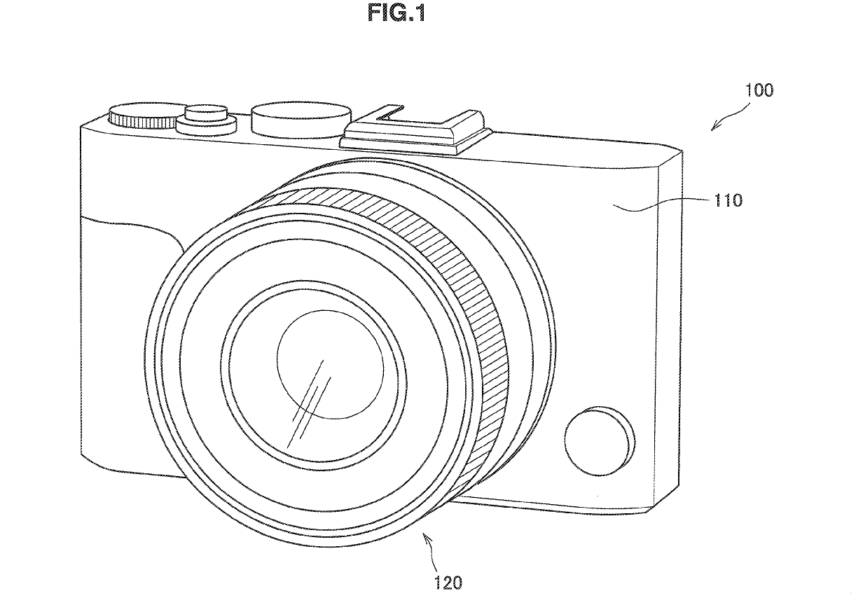

When describing the configuration of the drive device according to an embodiment of the present disclosure and the action thereof, the case of applying the drive device to a digital still camera 100 as illustrated in FIG. 1 will be described hereinafter. The digital still camera 100 includes a body part 110 having a control part that controls the entire imaging apparatus, an imaging device, a signal processing part that processes image signals acquired by the imaging device and the like, and a lens part 120 having a zoom lens, a focus lens, a correction lens part and the like. In the present embodiment, the case of application to lens drive of the lens part 120 will be described.

An application range of the drive device according to an embodiment of the present disclosure is not limited to a digital still camera and a lens drive device provided in the digital still camera. The drive device according to an embodiment of the present disclosure is widely applicable to a drive device for focusing and a device for shake correction of a lens incorporated in various kinds of devices such as a digital still camera, a video camera, a personal computer, and a cellular phone, or a shake correction device provided in an imaging apparatus or the like.

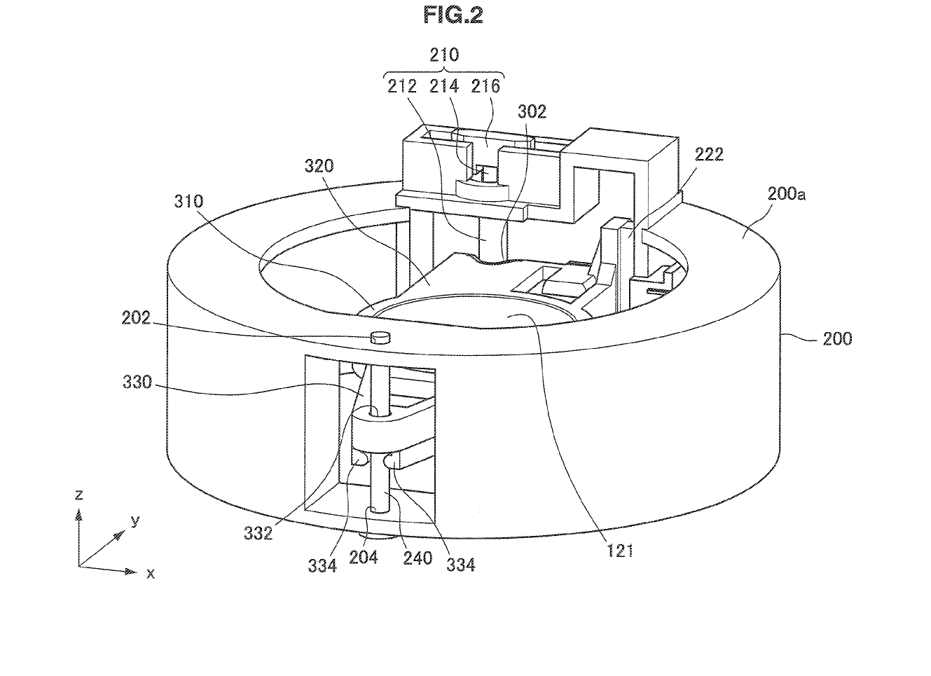

Also, the lens (reference numeral 121 in FIG. 2 and the like) indicated in the following description includes meanings of both of the one composed of a single lens and the one configured as a lens group by a plurality of lenses.

[1.2. Configuration]

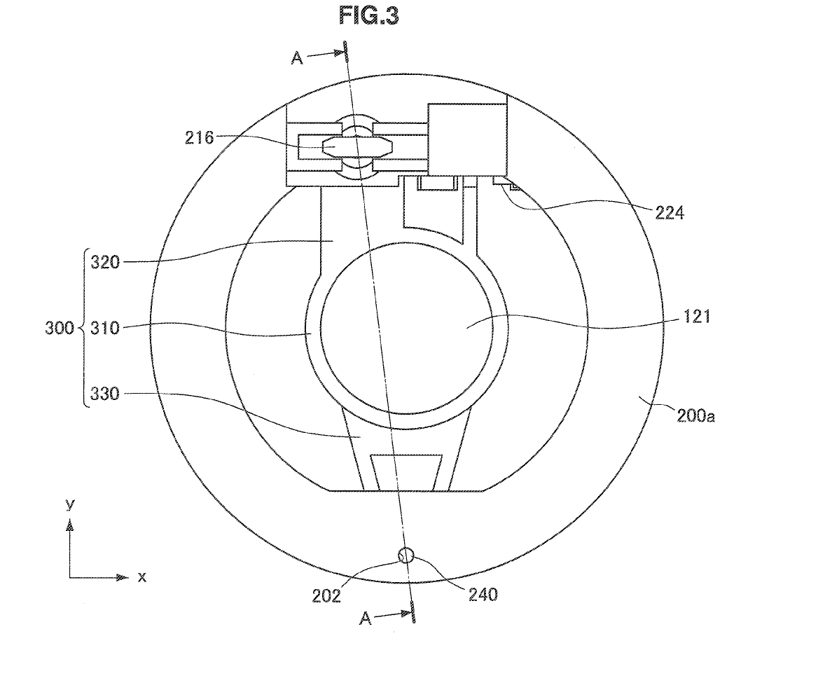

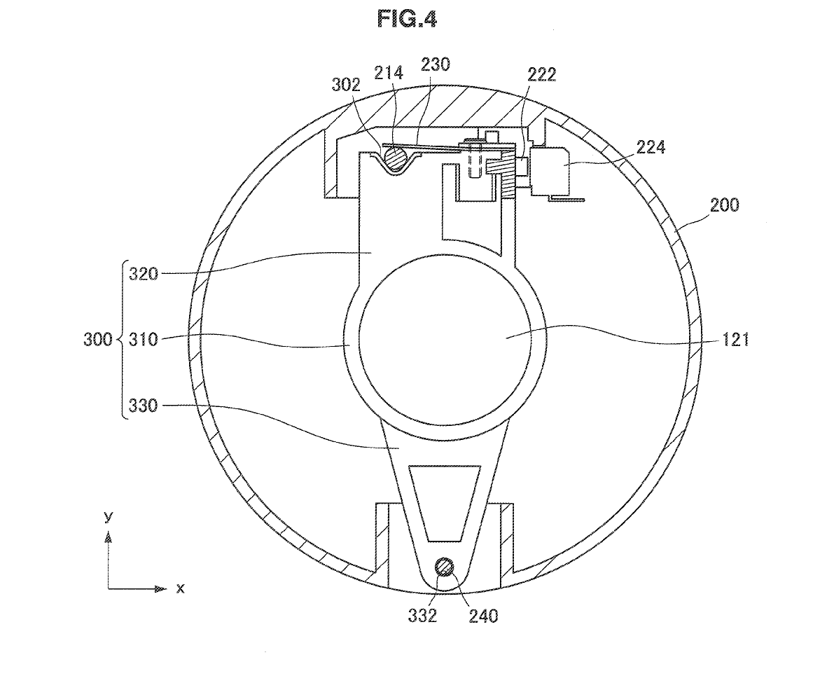

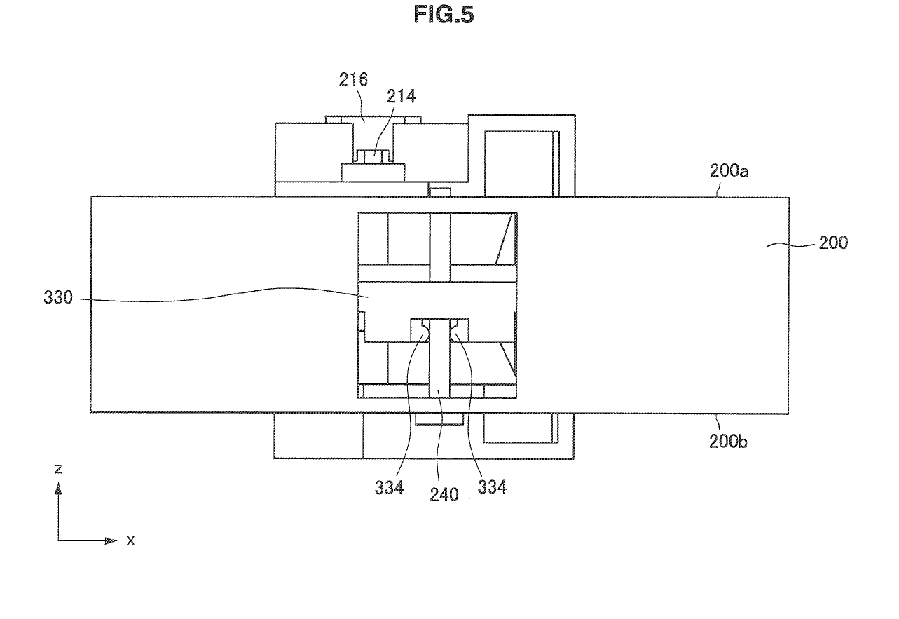

Referring to FIG. 2-FIG. 5, the configuration in the case of applying the drive device of the movable body by the piezoelectric actuator according to the embodiment of the present disclosure to a drive mechanism of a focusing lens will be described. FIG. 2 is a perspective view illustrating the configuration of the drive device according to the present embodiment. FIG. 3 is a plan view of the drive device according to the present embodiment. FIG. 4 is a planar sectional view of the drive device according to the present embodiment. FIG. 5 is a front view of the drive device according to the present embodiment.

The drive device according to the present embodiment includes, as illustrated in FIG. 2, a fixing member 200 fixed to the digital still camera 100, and a lens frame 300 that supports the lens 121 and is provided on the fixing member 200 movably in an optical axis direction. The lens 121 and the lens frame 300 are also called a movable body.

(1) Fixing Member

The fixing member 200 is a roughly cylindrical member and includes annular surfaces 200a, 200b projected toward a center axis at both ends of an opening. At a hollow part of the fixing member 200, the lens frame 300 is arranged. The fixing member 200 includes a drive shaft 212 and a sub shaft 240 of a piezoelectric actuator 210 provided in parallel with an optical axis respectively at positions roughly facing each other in a radial direction. By the drive shaft 212 and the sub shaft 240, the lens frame 300 is supported movably in an optical axis direction. The optical axis direction is identical to a center axis direction of the fixing member 200.

The piezoelectric actuator 210 includes a piezoelectric element 214 expanded and contracted in response to an applied voltage, the drive shaft 212 connected to one end side in an expanding/contracting direction of the piezoelectric element 214, and a weight 216 connected to the other end side in the expanding/contracting direction of the piezoelectric element 214. The piezoelectric element 214 and the drive shaft 212, and the piezoelectric element 214 and the weight 216 are fixed with an adhesive agent for instance.

The drive shaft 212 is a narrow round shaft member for instance. The drive shaft 212 is inserted to drive shaft support holes 201, 203 respectively formed on the annular surfaces 200a, 200b of the fixing member 200, and is slidably supported. Also, as illustrated in FIG. 4, with the drive shaft 212, a sliding contact surface 302 of the lens frame 300 is in contact between the drive shaft support holes 201, 203.

A drive shaft 212 is urged toward a sliding contact surface 302 by an urging member 230, and is frictionally connected with the lens frame 300. For the urging member 230, a leaf spring or the like for instance is usable. The urging member 230 is arranged so that a direction of urging force that urges the drive shaft 212 turns to the direction where a sub shaft 240 is arranged. In this way, the drive shaft 212 functions as a vibration member that drives the movable body, and also functions as a support member that supports the lens frame 300 in an axial direction.

The piezoelectric element 214 is expanded and contracted by a driving pulse voltage applied between electrodes, and generates reciprocating vibrations at different speeds. When the reciprocating vibrations of the piezoelectric element 214 are transmitted to the drive shaft 212, the lens frame 300 frictionally connected to the drive shaft 212 is moved in a direction of the vibrations at a low speed by asymmetry of the reciprocating vibrations of the drive shaft 212.

The weight 216 is a member having predetermined weight for efficiently transmitting expansion and contraction of the piezoelectric element to the drive shaft, and is formed into a block shape for instance.

The sub shaft 240 is a narrow round shaft member for instance. The sub shaft 240 is inserted and fixed to sub shaft support holes 202 and 204 respectively formed on the annular surfaces 200a, 200b of the fixing member 200. Also, the sub shaft 240 is inserted to a guide hole 332 of the lens frame 300 between the sub shaft support holes 202, 204. The lens frame 300 is provided movably in the optical axis direction along the sub shaft 240.

In the present embodiment, the drive shaft 212 and the sub shaft 240 are arranged so as to hold a centroid of the movable body including the lens 121 and the lens frame 300 therebetween. In this way, by arranging the centroid of the movable body on a straight line connecting the drive shaft 212 and the sub shaft 240, force and moment applied to the movable body can be supported with the minimum force by the drive shaft 212 and the sub shaft 240. The drive device according to an embodiment of the present disclosure is not limited to the example, and the drive shaft 212 and the sub shaft 240 may be arranged adjacently for instance.

Also, the fixing member 200 is provided with a magnetic sensor 224 as a position sensor that detects a position of the lens frame 300 holding the lens 121. The magnetic sensor 224 is provided so as to face a magnet 222 provided on the lens frame 300 along the optical axis direction. When the lens frame 300 is moved in the optical axis direction in response to the vibrations of the piezoelectric actuator 210, a position of the magnet 222 is also moved together with the lens frame 300. The magnetic sensor 224 specifies the position of the lens frame 300 by detecting intensity of a magnetic field that changes depending on the position of the magnet 222.

(2) Lens Frame

The lens frame 300 is, as illustrated in FIG. 3, a member that is arranged at the hollow part of the fixing member 200 and supports the lens 121. The lens frame 300 includes a lens holding part 310 that holds the lens 121, a first arm part 320 that is extended from the lens holding part 310 to the side of the drive shaft 212, and a second arm part 330 extended from the lens holding part 310 to the side of the sub shaft 240.

On the first arm part 320, the sliding contact surface 302 that is in contact with the drive shaft 212 and supports it along the axial direction is formed. At this time, the sliding contact surface 302 is, as illustrated in FIG. 4, arranged so as to be held between the drive shaft 212 and the sub shaft 240 in the view from a plane. The sliding contact surface 302 is frictionally connected with the drive shaft 212 urged toward a direction in which the sub shaft 240 is arranged by an urging member 230. Also, the sliding contact surface 302 is in contact with an outer peripheral surface of the drive shaft 212 at a plurality of parts, and is formed such that a cross sectional shape in a direction orthogonal to the optical axis is an almost V shape or an almost U shape for instance.

In this way, by arranging the sliding contact surface 302 in a shape to be in contact with the outer peripheral surface of the drive shaft 212 at a plurality of parts between the drive shaft 212 and the sub shaft 240, movement to directions other than a driving direction of the drive shaft 212 (that is, the optical axis direction) is regulated by the sliding contact surface 302. Therefore, regardless of the presence/absence of urging force by the urging member 230, the inclination of the lens frame 300 and the movement of the lens frame 300 to directions other than the driving direction can be suppressed. Also generation of reaction against the urging force of the urging member 230 can be reduced as well. The first arm part 320 is provided with a magnet 222 so as to face the magnetic sensor 224 that detects the position of the lens frame 300.

On the second arm part 330, a guide hole 332 through which the sub shaft 240 is to be inserted is formed. An inner diameter of the guide hole 332 is larger than an outer diameter of the sub shaft 240, and the drive shaft 212 and the sub shaft 240 originally arranged in parallel are formed so as to have such a clearance that the sub shaft 240 and the guide hole 332 are not brought into contact even when considering inclination of the sub shaft 240 that is generated within dimensional tolerance of components. The guide hole 332 also functions as an impact dispersing part that prevents the lens frame 300 from being inclined by a predetermined angle or more and giving a great impact on the drive shaft 212 when the lens frame 300 is inclined to the drive shaft 212 due to the generation of the impact. An impact dispersing function by the guide hole 332 will be described later.

Also, the second arm part 330 includes a pair of projection parts 334, 334 in contact with an outer peripheral surface of the sub shaft 240 so as to hold the sub shaft 240 therebetween. For the projection parts 334, 334, as illustrated in FIG. 5, the shape viewed from the front is formed into a roughly semicircular block shape projected to the sub shaft 240 for instance. Thus, the sub shaft 240 can be surely supported with few contact parts. Note that, the shape of the projection parts 334, 334 are not limited to the example, and the shape viewed from the front may be a V shape projected to the sub shaft 240 for instance.

The projection parts 334, 334 are provided so as to hold the sub shaft 240 therebetween from a rotating direction of the lens frame 300 with the drive shaft 212 as the rotation center. Thus, the movement of the lens frame 300 rotating around the drive shaft 212 is regulated. In the present embodiment, the individual projection parts 334, 334 are provided so that straight distances from the drive shaft 212 to the individual projection parts 334, 334 are almost the same.

Note that, while the pair of projection parts 334, 334 are provided on a z axis negative direction side with respect to the guide hole 332 as illustrated in FIG. 2 and FIG. 5 in the present embodiment, the present disclosure is not limited to the example, and the pair of projection parts 334, 334 may be provided on a z axis positive direction side with respect to the guide hole 332. Also, the pair of projection parts 334, 334 may not be arranged closely in a z direction to the guide hole 332 as in the present embodiment, may be arranged at a predetermined distance in the z direction from the guide hole 332 for instance, or may be provided inside the guide hole 332. Alternatively, the guide hole 332 may be divided into two and the pair of projection parts 334, 334 may be provided so as to be held between the two guide holes.

<2. Action of Drive Device>

[2.1. Movement of Lens Frame by Piezoelectric Actuator]

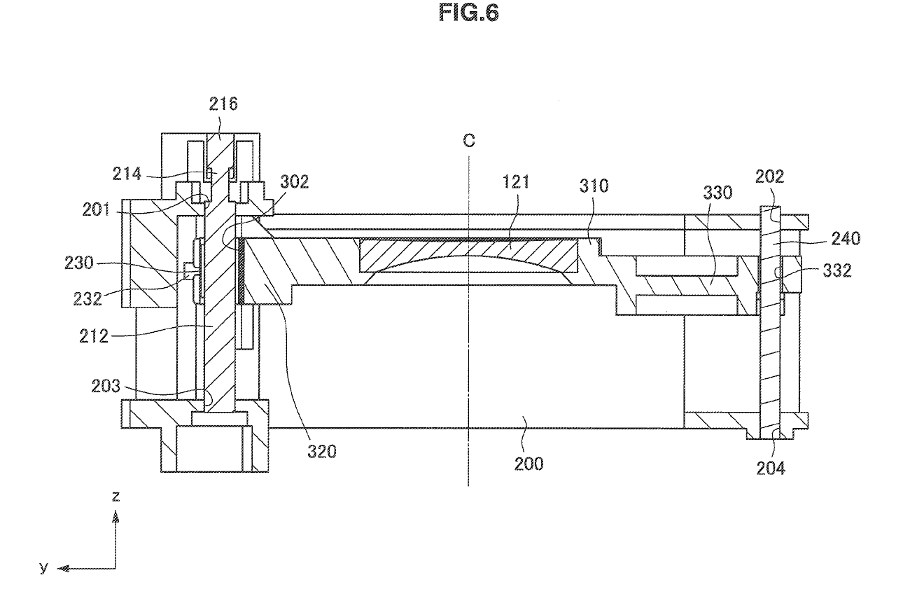

The drive device according to the present embodiment moves the lens frame 300 that holds the lens 121 in the optical axis direction with the piezoelectric actuator 210. Normally, the drive device is configured such that, as illustrated in FIG. 6, an optical axis C of the lens 121 held by the lens frame 300, the drive shaft 212 and the sub shaft 240 are parallel to one another. FIG. 6 is a sectional view on an A-A cutting line in FIG. 3.

In a state illustrated in FIG. 6, when a voltage is applied to the piezoelectric element 214 of the piezoelectric actuator 210, the piezoelectric element 214 is expanded, contracted and vibrated in a reciprocating manner. When reciprocating vibrations of the piezoelectric element 214 are transmitted to the drive shaft 212, the lens frame 300 frictionally connected to the drive shaft 212 is moved in a low-speed vibrating direction due to asymmetry of the reciprocating vibrations of the drive shaft 212. In this way, the lens frame 300 is moved in the optical axis direction in response to the voltage applied to the piezoelectric element 214. At this time, the sub shaft 240 is not in contact with the guide hole 332 of the lens frame 300, and thus does not obstruct the movement of the lens frame 300.

[2.2 Impact Dispersing Function by Lens Hole]

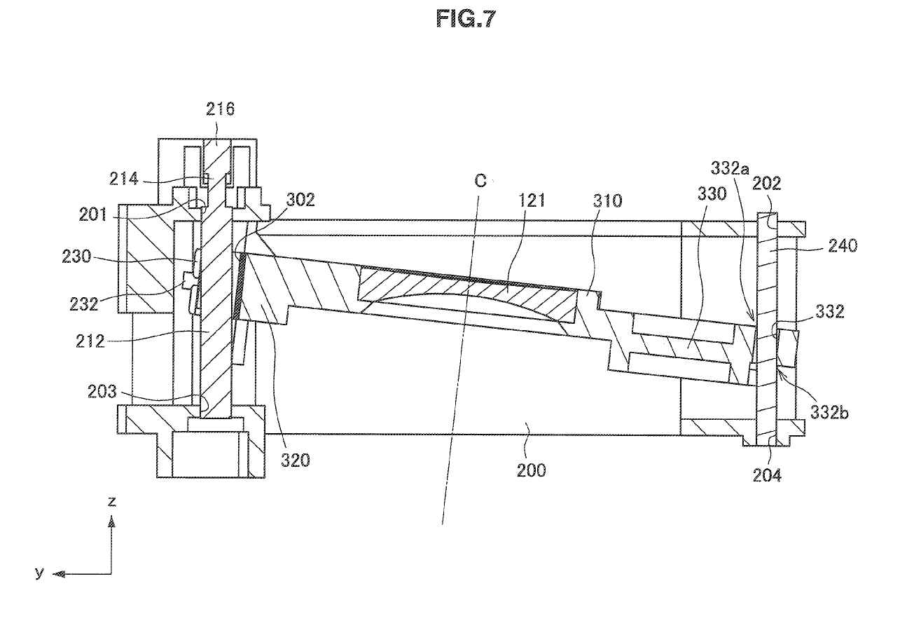

In the drive device according to the present embodiment, in order to prevent the piezoelectric element 214 from being damaged by an impact generated by the fall or the like of an apparatus including the drive device, the guide hole 332 of the lens frame 300 through which the sub shaft 240 is to be inserted is made to function as the impact dispersing part. On the basis of FIG. 6 and FIG. 7, the impact dispersing function by the lens hole 332 will be described. FIG. 7 is a sectional view on the A-A cutting line in FIG. 3, and illustrates a state that the lens frame 300 is inclined by an impact.

When an impact is applied to the apparatus provided with the drive device, the lens frame 300 of the drive device is shifted, and the optical axis of the lens 121 is inclined to the drive shaft 212 and the sub shaft 240. At this time, as illustrated in FIG. 7, openings 332a, 332b of the guide hole 332 are brought into contact with the sub shaft 240 so that the lens frame 300 is not inclined by a predetermined angle or more. By suppressing the inclination of the lens frame 300 to the drive shaft 212 and the sub shaft 240 to the predetermined angle, an impact given by the lens frame 300 to the drive shaft 212 can be suppressed, and an impact transmitted from the drive shaft 212 to the piezoelectric element 214 can be also suppressed. Alternatively, by the openings 332a, 332b of the guide hole 332 being in contact with the sub shaft 240, an impact from the lens frame 300 can be efficiently dispersed to the sub shaft 240. Thus, the damage to the piezoelectric element 214 can be prevented.

Therefore, the size of the guide hole 332 is set such that an impact to be given to the piezoelectric element 214 through the drive shaft 212 when the lens frame 300 is inclined can be suppressed so as not to damage the piezoelectric element 214. That is, the size of the guide hole 332 is determined to hold the inclination of the lens frame 300 at such an inclination angle of the optical axis C of the lens 121 to the drive shaft 212 and the sub shaft 240 that an impact can be suppressed so as not to damage the piezoelectric element 214.

Also, as illustrated in FIG. 4, by making the shape of the guide hole 332 be circular, the inclination of the lens frame 300 can be regulated in every direction. In this case, by providing both the guide hole 332 and the sub shaft 240 so as to form a concentric circle, an inclination regulation amount of the lens frame 300 can be made equal in every direction.

[2.3 Rotation Regulating Function by Projection Parts]

In the drive device according to the present embodiment, the second arm part 330 of the lens frame 300 includes a pair of projection parts 334, 334 in contact with the outer peripheral surface of the sub shaft 240 so as to hold the sub shaft 240 therebetween. By providing the projection parts 334, 334 so as to hold the sub shaft 240 therebetween from the rotating direction of the lens frame 300 with the drive shaft 212 as the rotation center, the rotation movement of the lens frame 300 around the drive shaft 212 is regulated.

In the drive device according to the present embodiment, the projection parts 334, 334 are provided so as to act on the sub shaft 240 together with the guide hole 332 which is the impact dispersing part of the piezoelectric element 214. In this way, by utilizing the sub shaft 240 and providing a function of dispersing an impact to the piezoelectric element 214 and a function of regulating the rotation of the lens frame 300 together, the configuration of the drive device can be simplified and the drive device can be miniaturized.

<3. Summary>

The configuration of the drive device according to one embodiment of the present disclosure and the action thereof are described above. When an impact is applied to the apparatus provided with the drive device, the lens 121 and the lens frame 300 holding the lens 121 as the movable body of the drive device are shifted, and inclined to the drive shaft 212 and the sub shaft 240. At this time, the drive device according to the present embodiment prevents damage to the piezoelectric element 214 by suppressing the transmission of an impact generated by the inclination of the lens frame 300 to the piezoelectric element 214 with the guide hole 332 which is the impact dispersing part.

Also, the drive device includes the pair of projection parts 334, 334 which are the rotation regulating member that regulates the rotation of the lens frame 300 with the drive shaft 212 as the rotation center, so as to act on the sub shaft 240 together with the impact dispersion part. In this way, by utilizing the sub shaft 240 and providing the function of dispersing an impact to the piezoelectric element 214 and the function of regulating the rotation of the movable body together, the configuration of the drive device can be simplified and the drive device can be miniaturized. Also, by simplifying the configuration of the drive device, drive force of the piezoelectric actuator 210 can be correctly transmitted to the lens frame 300.

The preferred embodiments of the present disclosure are described above in detail with reference to the appended drawings, but the technical scope of the present disclosure is not limited to the examples. It is clear that a person ordinarily skilled in the art of the present disclosure can conceive various kinds of change examples or correction examples within the scope of technical ideas described in the claims, and it is understood that they of course belong to the technical scope of the present disclosure.

For instance, in the above-described embodiment, the drive device that moves the lens in the optical axis direction is described; however, the present disclosure is not limited to the example. For instance, the drive device is applicable also to the case of moving the lens in a direction orthogonal to the optical axis.

Also, while the shape of the guide hole 332 is circular in the above-described embodiment, the present disclosure is not limited to the example. For instance, the guide hole 332 may be roughly elliptic or rectangular or the like, or may be composed of a combination of an almost V shape and an almost U shape.

Further, in the above-described embodiment, the projection parts 334, 334 are provided as the rotation regulating member that regulates the rotation of the lens frame 300 with the drive shaft 212 as the rotation center; however, the present disclosure is not limited to the example. For instance, three or more projection parts may be provided to form the rotation regulating member, or the rotation of the lens frame 300 may be regulated by a configuration other than holding the sub shaft 240 between the projection parts 334, 334.

Also, the effects described in this specification are only explanations or examples and are not definite. That is, the technology according to the present disclosure can demonstrate other effects that are clear to those skilled in the art from descriptions of this specification, together with the above-described effects, or instead of the above-described effects.

Additionally, the present technology may also be configured as below.

(1) A drive device including:
a movable body; and
a fixing member that supports, with a drive shaft driven by a piezoelectric element expanded and contracted in response to an applied voltage and a sub shaft provided in parallel with the drive shaft, the movable body connected with the drive shaft movably in an axial direction,
wherein the movable body includes
a rotation regulating member that supports the sub shaft and regulates rotation of the movable body with the drive shaft as a rotation center, and
an impact dispersing part that disperses an impact on the piezoelectric element when inclined to the drive shaft.
   (2) The drive device according to (1),
wherein the impact dispersing part is a guide hole through which the sub shaft is to be inserted, and
wherein the guide hole is formed so as to be in contact with the sub shaft at an opening of the guide hole when the movable body is inclined by a predetermined angle to the drive shaft.
   (3) The drive device according to (2),
wherein a shape of the guide hole is circular.
   (4) The drive device according to any one of (1) to (3),
wherein the rotation regulating member includes a pair of projection parts that hold the sub shaft therebetween from a rotating direction of the movable body with the drive shaft as a rotation center.

(5) The drive device according to any one of (1) to (4), including
an urging member that applies fixed urging force to a movable body sliding contact surface of the movable body in contact with a peripheral surface of the drive shaft at a plurality of parts,
wherein the movable body sliding contact surface is arranged such that a direction of the urging force by the urging member is turned to a direction where the sub shaft is arranged.
   (6) The drive device according to any one of (1) to (5),
wherein a centroid of the movable body is positioned on a straight line connecting the drive shaft and the sub shaft.
   (7) An imaging apparatus including:
an imaging unit;
a lens part composed of one or more lenses that transmit light incident on the imaging unit; and
a plurality of drive devices that are provided in the imaging unit and the lens respectively and move the imaging unit and the lens in a predetermined direction respectively,
wherein at least one of the drive devices includes
a movable body composed of the imaging unit or the lens to be moved by the drive device, and a holding part that holds the imaging unit or the lens, and
a fixing member that supports, with a drive shaft driven by a piezoelectric element expanded and contracted in response to an applied voltage and a sub shaft provided in parallel with the drive shaft, the movable body connected with the drive shaft movably in an axial direction, and
wherein the movable body includes
a rotation regulating member that supports the sub shaft and regulates rotation of the movable body with the drive shaft as a rotation center, and
an impact dispersing part that disperses an impact on the piezoelectric element when inclined to the drive shaft.

What is claimed is:

1. A drive device comprising:
a movable body; and
a fixing member that supports, with a drive shaft driven by a piezoelectric element expanded and contracted in response to an applied voltage and a sub shaft provided in parallel with the drive shaft, the movable body connected with the drive shaft movably in an axial direction,
wherein the movable body includes
a rotation regulating member that supports the sub shaft and regulates rotation of the movable body with the drive shaft as a rotation center, and
an impact dispersing part that disperses an impact on the piezoelectric element when inclined to the drive shaft.

2. The drive device according to claim 1,
wherein the impact dispersing part is a guide hole through which the sub shaft is to be inserted, and
wherein the guide hole is formed so as to be in contact with the sub shaft at an opening of the guide hole when the movable body is inclined by a predetermined angle to the drive shaft.

3. The drive device according to claim 2,
wherein a shape of the guide hole is circular.

4. The drive device according to claim 1,
wherein the rotation regulating member comprises a pair of projection parts that hold the sub shaft therebetween from a rotating direction of the movable body with the drive shaft as a rotation center.

5. The drive device according to claim 1, comprising
an urging member that applies fixed urging force to a movable body sliding contact surface of the movable body in contact with a peripheral surface of the drive shaft at a plurality of parts,
wherein the movable body sliding contact surface is arranged such that a direction of the urging force by the urging member is turned to a direction where the sub shaft is arranged.

6. The drive device according to claim 1,
wherein a centroid of the movable body is positioned on a straight line connecting the drive shaft and the sub shaft.

7. An imaging apparatus comprising:
an imaging unit;
a lens part composed of one or more lenses that transmit light incident on the imaging unit; and
a plurality of drive devices that are provided in the imaging unit and the lens respectively and move the imaging unit and the lens in a predetermined direction respectively,
wherein at least one of the drive devices includes
a movable body composed of the imaging unit or the lens to be moved by the drive device, and a holding part that holds the imaging unit or the lens, and
a fixing member that supports, with a drive shaft driven by a piezoelectric element expanded and contracted in response to an applied voltage and a sub shaft provided in parallel with the drive shaft, the movable body connected with the drive shaft movably in an axial direction, and
wherein the movable body includes
a rotation regulating member that supports the sub shaft and regulates rotation of the movable body with the drive shaft as a rotation center, and
an impact dispersing part that disperses an impact on the piezoelectric element when inclined to the drive shaft.
